(19) United States
(12) Patent Application Publication
(10) Pub. No.: US 2013/0275513 A1
(43) Pub. Date: Oct. 17, 2013

(54) WIRELESS AD-HOC NETWORK FACILITATING SOCIAL INTERACTIONS AMONG PLURALITY OF USERS

(71) Applicants: Valeriy Borovyk, Swampscott, MA (US); Dmytro Isaienko, Kyiv (UA)

(72) Inventors: Valeriy Borovyk, Swampscott, MA (US); Dmytro Isaienko, Kyiv (UA)

(21) Appl. No.: 13/977,099

(22) PCT Filed: Dec. 29, 2011
(86) PCT No.: PCT/US11/67694

§ 371 Date: Jun. 28, 2013

Related U.S. Application Data
(60) Provisional application No. 61/429,133, filed on Jan. 1, 2011.

(51) Int. Cl. H04W 84/18

(52) U.S. Cl. CPC H04W 84/18
USPC 709/204

(57) ABSTRACT

A wireless ad-hoc network for facilitating social interactions among a plurality of users includes a plurality of electronic devices associated with the plurality of users. An electronic device includes a transceiver module for establishing a direct communication link with the second electronic device and for generating an identification code associated with the second electronic device. A contacts module for maintaining a profile of a second user associated with the second electronic device and for mapping between the profile and corresponding identification code in response to establishing the direct communication link The electronic device also includes a social interaction module for searching the second electronic device based on the mapping and for enabling a social interaction with the second electronic device over the direct communication link, and a user interface module for rendering output information to and for receiving input information from a user of the electronic device.

### CROSS-REFERENCE TO RELATED APPLICATION

This application claims priority to and benefit of U.S. provisional application Ser. No. 61/429,133, filed on Jan. 1, 2011 and incorporated herein by reference.

### FIELD OF THE INVENTION

The present invention relates to wireless networking, and, more particularly, to a plurality of electronic devices forming a wireless ad-hoc network for facilitating social interactions among a plurality of users.

### BACKGROUND

Since ancient times, people come together to form groups having common interest or purpose to share information. With an advent of writing, people were able to establish communication over a distance, but such communication was time-consuming and inconvenient. Subsequent advancements in science and technology provided new faster modes of remote communication such as radio, telephone, and telegraph. Those technologies, however, were designed for quick transfer of information in real-time, and are poorly suited for dissemination of information among individual members of a group or community.

Computer networking and, in particular, the global system of interconnected computer networks known as the “Internet” greatly simplified remote communication, establishing a versatile medium for a complex array of interactions between vast numbers of individuals. The Internet has made keeping in touch with friends and acquaintances and making new ones more convenient than ever before. In order to facilitate multi-party communications, various Internet-based social networking applications have developed in recent years, providing an array of tools and forums for allowing these individuals to interact with one another via the social networking website. Many users, however, prefer to limit communications to specific groups of other users. With popular products, such as Facebook and Google+, people now can interact with each other and get organized in private groups to share and exchange information in real-time.

Unfortunately, Internet access is not always readily available. Until very recently, most people have used desktop personal computers to connect to the Internet. Access to Internet via smartphones, tablets, and other portable devices often is not affordable for many people. Moreover, in many parts of the world, the mobile Internet is not available at all. Therefore, there is a need in the art to provide new opportunities for building social networks without relying on the Internet.

Various techniques have been proposed for implementing ad-hoc peer-to-peer communication networks. For example, U.S. Pat. No. 7,216,282 discloses a mobile ad-hoc network including a source node, a destination node, and a plurality of intermediate nodes. The source node may establish a plurality of routes to the destination node for transferring data therebetween, where each route passes through at least one of the intermediate nodes. Also, U.S. Pat. No. 7,573,835 discloses a method of communicating information in a communication network with a plurality of hierarchically addressed nodes includes receiving communication packets identifying 1-hop neighbor node addresses, a number of on-tree neighbors of neighbor nodes transmitting the received packets, and forwarding node addresses of forwarding nodes from which information in the received packets are to be rebroadcast.

Further, U.S. Pat. No. 7,787,450 discloses a particular network formation technique for mobile ad-hoc wireless networks to overcome bandwidth overhead due to generation of database update or Link State Advertisement (LSA) messages in response to changes in certain parameters (e.g., node group size, etc.) with respect to both single and plural node group scenarios. These and other conventional approaches to ad-hoc networking, however, are not readily suitable to enable a full range of social interaction between their users.

### SUMMARY

Applicants herein generally recognized and appreciated the need for and the advantages of social interactions that unite people without the use of the Internet. Moreover, Applicants further recognize the possibility of transforming ad-hoc networking techniques to form a wireless ad-hoc network, particularly suitable for facilitating social interactions among a plurality of users. Accordingly, in its various implementations and embodiments, the present invention relates to a plurality of electronic devices configured for forming a wireless ad-hoc network without the use of Internet connectivity, and enabling a variety of social interactions between users.

Any two electronic devices of the network are able to communicate to each other using a communication path formed by a set of communication links between electronic devices located within a single radio hop from each other. The communication over the direct communication path is contrasted herein with the communication over the Internet that employs dedicated communication servers. The communication over the Internet is impossible without involvement of a third party, commonly referred to as an “Internet service provider”, which enables the connectivity among user via its proprietary servers.

In contrast, the plurality of electronic devices employing the principles of the invention are able to communicate to each other directly, if located within a single radio hop away, or through a peer electronic device that acts as a router forwarding packets of information from one electronic device to another. Accordingly, the plurality of the electronic devices can form a decentralized, mobile ad-hoc network without assistance from any third party, and thus, without the Internet. Accordingly, such electronic devices equipped with appropriate functionality can facilitate social interactions between remote users without relying on wireless Internet connectivity.

As understood in the art and used herein, the term “social interactions” includes, but is not limited to, various types of information exchange between two or more individuals, such as voice and/or video communications, exchange and posting of text messages, scheduling of events, posting calendar entries and status updates, management of user profiles within a community, exchanging and posting geographical locations of the users, etc.

Generally, in one aspect, the present invention relates to a wireless ad-hoc network for facilitating social interactions among a plurality of users. The network is formed by a plurality of electronic devices associated with the plurality of users, including a first electronic device and a second electronic device each having similar configuration and functionalities.

For example, the first electronic device can include a transceiver module for establishing a communication path with the second electronic device and for generating an identification code associated with the second electronic device. The first electronic device may also include a contacts module for maintaining a profile of a second user associated with the second electronic device and for mapping between the profile and corresponding identification code in response to establishing the communication path. Also, the first electronic device may include a social interaction module for searching the second electronic device based on the mapping and for enabling a social interaction with the second user over the communication path, and a user interface module for rendering output information to and for receiving input information from a first user of the first electronic device.

The transceiver module may include a transceiver for transmitting and receiving data and a memory for storing a routing table including routing data representing at least a part of the communication path. If the first and the second electronic device are located within a single radio hop to each other, they may communicate directly over the communication link. However, in some situations, the communication path includes multiple links. Thus, in one variation of this embodiment, the routing data indicates that the communication path between the first electronic device and the second electronic device includes a link to a third electronic device of the plurality of electronic devices. Thus, the transceiver, according to the routing table, transmits the data for the second electronic device to the third electronic device.

Also, in some embodiments, the transceiver module broadcasts an identification packet including at least part of the routing data, and modifies the routing table in response to receiving a plurality of identification packets broadcasted by the plurality of electronic devices of the network. For example, the transceiver module can broadcast the identification packet in response to modification of the routing table. In such manner, the routing table of each electronic device is populated and updated, and each electronic device stores up to date topology of the network.

Various embodiments of the invention use different communication protocols. Importantly, such protocols are used “as is” or modified to establish direct communication links connecting electronic devices. For example, in some embodiments, the electronic devices form an ad-hoc decentralized communication network based on a ZigBee communication protocol.

In some embodiments, the electronic device may include a contacts module for maintaining a profile of a second user associated with the second electronic device and for mapping between the profile and corresponding identification code in response to establishing the direct communication link. In those embodiments, the contacts module is configured to indicate to a user of the first electronic device that a user of the second electronic device joined the network. Also, the mapping generated by the contacts module may be used to perform a search of the user of the second device within the network based on a corresponding profile of the user.

In some embodiments, the electronic device also includes a social interaction module for searching the second electronic device based on the mapping and for enabling a social interaction with the second electronic device over the direct communication link. The social interaction module may provide a variety of functionalities similar to the functionalities of the conventional Internet-based social networks. For example, the social interaction can include at least one or combination of voice and/or video communications, exchange and posting of text messages, scheduling of events, posting calendar entries and status updates, management of user profiles within a community, exchanging and posting geographical locations of the users, etc.

In some embodiments, the first and/or the second electronic device also includes a user interface module for rendering output information to and for receiving input information from a user of the device via different types of input/output terminals. For example, the user interface module may include a touchscreen including an output layer and an input layer, wherein the input layer includes at least one of a conductive layer, an ultrasonic waves layer, an electrostatic field layer, or combination thereof.

Some embodiments of the invention stem from a realization that the electronic device disclosed herein can be used in conjunction with an external device, e.g., a conventional smartphone. In these embodiments, the electronic device employing the principles of the invention can be used to adapt the external device to be used within the wireless ad-hoc network, and, thus, the electronic device can reuse some hardware and functionality of the external device. In one embodiment of the invention, the user interface module includes a connector module for connecting the first electronic device to an external device such that the user interface module renders the output information on the external device, and receives the input information from the external device.

Some embodiments of the invention take an advantage from another realization that the electronic device can be used not only for remote social interactions, but also for facilitating personal face-to-face contacts. During recent years, the Internet has become a vital part of everyone's daily life. People have become dependent upon communication on the Internet, which brings a great variety of advantages; however, at the same time they continue to rely heavily upon interpersonal communication, which cannot be substituted by the Internet. And every day, thousands of people face the same problem—how to get into the first contact with the unknown person; they simply don't know how to deal with their fears to be able to come up to a potential friend or partner, introduce oneself and engage in a conversation. Since the Internet appeared in our everyday lives, the online lives have become much easier, but what the offline, or real, lives still remain rather complicated. Applicants herein have generally realized that, in practice, the network formed by the electronic devices employing principles of the invention has a limited coverage, especially when compared with the coverage of the Internet. Accordingly, users of the first and the second electronic devices are probably located within walking or at least driving distance from each other. Accordingly, the electronic devices employing the principles of the invention can be used to find a partner for a face-to-face conversation, locate a friend from a contact list who is passing nearby, or to introduce oneself to a friend-to-be.

Thus, some embodiments of the invention may include a reference module for determining at least one of a direction and a distance from the first electronic device to the second electronic device. Knowing the direction and the distance to the second electronic device, the first user of the first electronic device may decide to establish a personal contact with the second user. For example, in one embodiment the user interface module renders an indicator of the second electronic device on a screen of the first electronic device. The indicator may reflect parameters of the profile of the second user. The indicator can also have a geometric parameter, e.g., as a function of at least one of the direction and the distance. The geometric parameter serves to indicate to the first user a scaled distance and the direction to the second user. For example, in some embodiments the indicator is rendered as a line or an arrow pointing to a rendered name of the second user, wherein a length of the line on the screen is a function of the distance, and an orientation of the line on the screen is a function of the direction.

In some embodiments of the invention, the reference module includes global positioning service (GPS) system. However, alternative embodiments are based on another realization that the electronic devices of the ad-hoc network can be used in premises or part of the world wherein global positioning service (GPS) is unavailable. Also, the users of the network can be so close to each other that the GPS system would not be very useful. Therefore, in some embodiments, in place of GPS, the reference module can include an accelerometer and a compass for determining at least one of a spatial position and an orientation of the first electronic device. For example, the reference module can determine an initial position of the electronic device relative to the second electronic device and can update the position and the orientation based on the accelerometer and the compass. In one variation of this embodiment, the initial position is determined based on a fixed position of a ZigBee coordinator.

In yet another aspect, the invention relates to a networkable electronic device, including a transceiver module for establishing a communication path with at least one other networkable electronic device and for generating an identification code associated with the at least one other networkable electronic device, wherein the communication path is formed by a set of links, each link connects two electronic devices located within a single radio hop in the network and a contacts module for maintaining a profile of a user associated with the at least one other networkable electronic device and for mapping between the profile and corresponding identification code in response to establishing the communication path. The device also includes a social interaction module for searching the at least one other networkable electronic device based on the mapping and for enabling a social interaction with the user of the at least one other networkable electronic device over the communication path; and a user interface module for rendering output information to and for receiving input information from a user of the networkable electronic device. The transceiver module may include a transceiver for transmitting and receiving data; a memory for storing a routing table including routing data representing at least a part of the communication path; and a network module for modifying the routing table in response to receiving a plurality of identification packets broadcasted by at least two other networkable electronic devices.

In some embodiments, the device further includes a reference module for determining at least one of a direction and a distance to the at least one other networkable electronic device. Also, in some versions of these embodiments, the user interface module renders an indicator of the at least one other networkable electronic device on a screen, such that a geometric parameter of the indicator on the screen is a function of at least one of the direction and the distance. The reference module may include an accelerometer and a compass for determining at least one of a spatial position and an orientation of the first electronic device, and wherein the reference module determines an initial position of the electronic device relative to the at least one other networkable electronic device and updates the position and the orientation based on the accelerometer and the compass.

In another aspect, the present disclosure is directed to a wireless ad-hoc network for facilitating social interactions between multiple users, the network comprising a plurality of electronic devices associated with the users. Each electronic device includes a transceiver for connecting to the network based on a ZigBee communication protocol; a social interaction module for enabling the social interactions with at least some of the plurality of electronic devices of the network over the ZigBee communication protocol; and a reference module for determining at least one of a direction and a distance from the electronic device to at least some of the plurality of the electronic devices.

In yet another aspect, the present disclosure is directed to a method for a social networking within decentralized, mobile and ad hoc social networking community. The method includes forming an ad-hoc decentralized communication network based on a ZigBee communication protocol; and integrating into the communication network a plurality of social interactions.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a schematic of a wireless ad-hoc network facilitating social interactions according to some embodiments of an invention;

FIGS. 2 and 3 are block diagram of modules of an electronic device forming the network of FIG. 1;

FIG. 4 is an illustration of a functionality of a reference module according to some embodiments of the invention;

FIG. 5A-E are examples illustrating a method for population of routing tables of electronic devices;

FIG. 6 is an example of an object model of the key tables in the relational database maintained by the electronic device;

FIG. 7 depicts a pseudo graphical user interface in which a user enters information in specific data fields to create a personal data record;

FIG. 8 depicts a pseudo graphical user interface for listing other users with the same group affiliation as that specified by a first user;

FIG. 9 depicts a pseudo graphical user interface for specifying what type of data fields from a first user's personal data record to which the first user wishes to grant a specific second user access;

FIG. 10 depicts a pseudo graphical user interface that displays the information stored in a user's personal address book; and

FIG. 11 depicts a pseudo graphical user interface that allows a first user to gather information about the contacts of his contacts.

### DETAILED DESCRIPTION

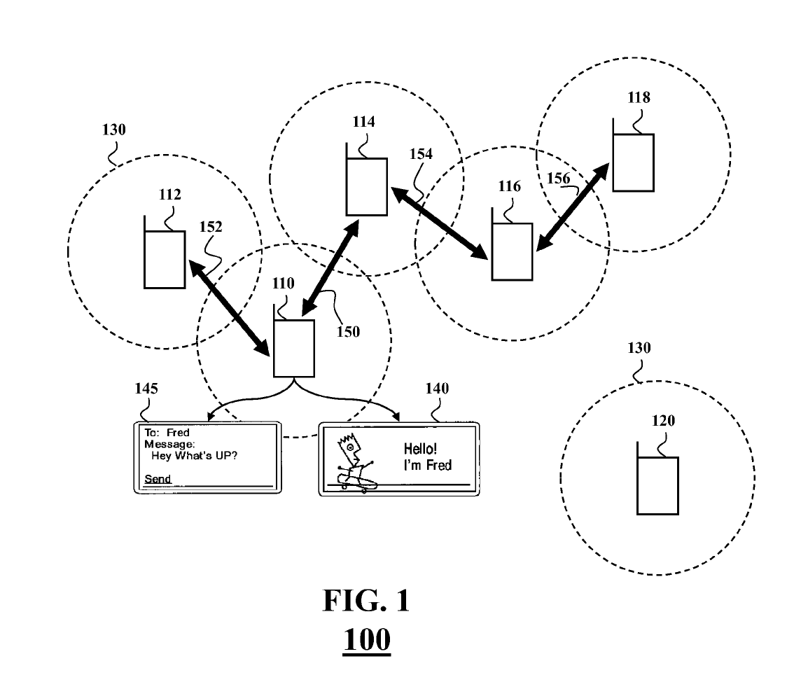

FIG. 1 shows a wireless ad-hoc network 100 for facilitating social interactions among a plurality of users according to some embodiments of an invention. The network 100 is formed by a plurality of electronic devices associated with the plurality of users. Referring to FIG. 1, the network includes a first electronic device 110 associated with a first user and a second electronic device 114 associated with a second user. In addition to ability of forming the network, each electronic device is configured to facilitate social interactions among the users of the electronic devices. The network 100 is a decentralized wireless network and may include unlimited number of electronic devices described in more detail below. The network is ad-hoc because does not rely on a preexisting infrastructure, such as routers in wired networks or access points in managed (infrastructure) wireless networks. Instead, each electronic device is a node of the network that participates in routing by forwarding data for other nodes, and the determination of which electronic device forward data is made dynamically based on the network connectivity. Thus, such electronic devices equipped with appropriate functionality form the decentralized, mobile ad-hoc social network that facilitates social interactions between the users without relying on the Internet connectivity.

In many embodiments of the invention, to be connected to the network, the electronic device 110 is preferably located within a single radio hop from at least one other electronic device of the network. A circle 130 illustrates a half distance of the single radio hop, such that if the circles 130 of two electronic devices intersect, the two electronic devices can be connected by a communication link. For example, the electronic device 110 is connected to the electronic devices 114 and 112 via communication links 150 and 152, respectively. In the example of FIG. 1, the electronic devices 110, 112, 114, 116, and 118 form the same network, because each of those electronic device is connected to at least another electronic device via the communication link. Accordingly, each electronic device in the network is connected to any other electronic device based on a communication path formed by a set of communication links. For example, the communication path between the electronic device 110 and 116 may be established using two communication links 150 and 154. Similarly, the communication path between the electronic device 110 and 118 may be established using three communication links 150, 154 and 156.

The user of the electronic device does not have to know a topology of the communication path connecting the electronic device with another electronic device. What important for the user is that the electronic device of another user is connected to the network. For example, an electronic device 120 is not part of the network 100, because a single radio hop 130 does not connect the electronic device 120 with at least one other electronic device of the network. However, if the user of the electronic device 120 relocates within the single radio hop of any other electronic device of the network, the electronic device 120 becomes part of the network and can be connected using corresponding direct communication path to any other electronic device of the network.

For example, the user of electronic device 110 can receive a message, e.g., in a form of an image 140, when the electronic device of a user named “Fred” is present or joins the network. That means that the communication path between the electronic device 110 and the electronic device of Fred is established, and a social interaction such as sending a message 145 can be performed.

As discussed above, the communication among a plurality of electronic devices 120 is contrasted herein with the communication over the Internet, because the Internet communication uses indirect connection based on a plurality of dedicated servers. The Internet is a global system of interconnected computer networks that use the standard Internet protocol suite (TCP/IP) to serve billions of users worldwide. The Internet defines the two principal name spaces, i.e., the Internet protocol address space and the domain name system (DSN), are directed by a maintainer organization, the Internet Corporation for Assigned Names and Numbers (ICANN). Accordingly, despite the fact that Internet has no centralized government, the communication over the Internet is impossible without involvement of a third party, e.g., an infrastructure provides by the Internet service provider.

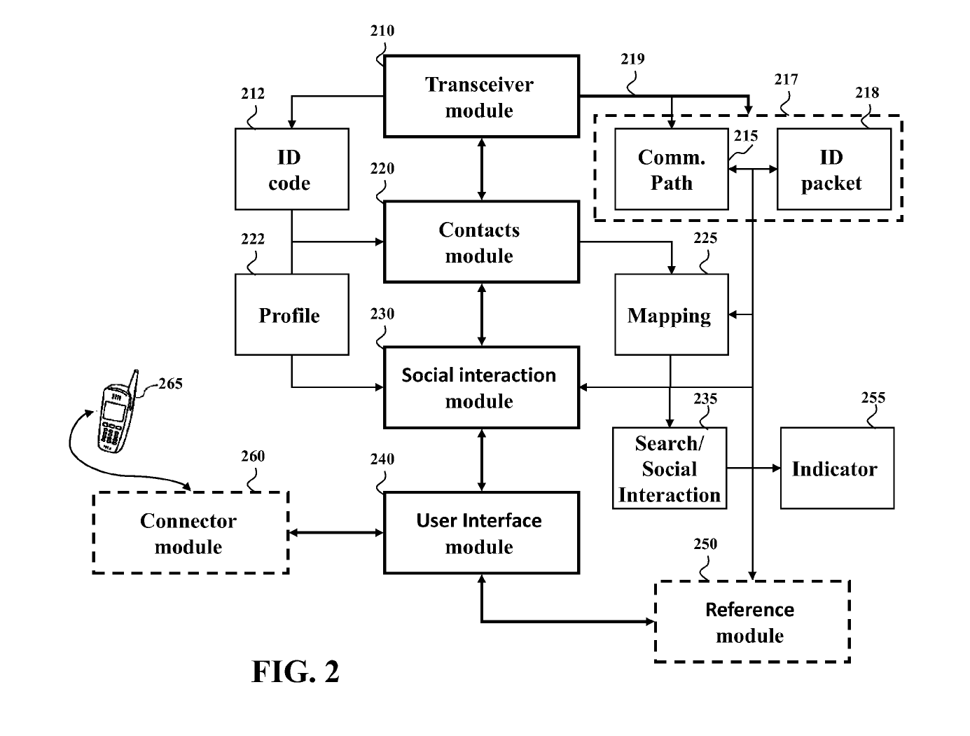

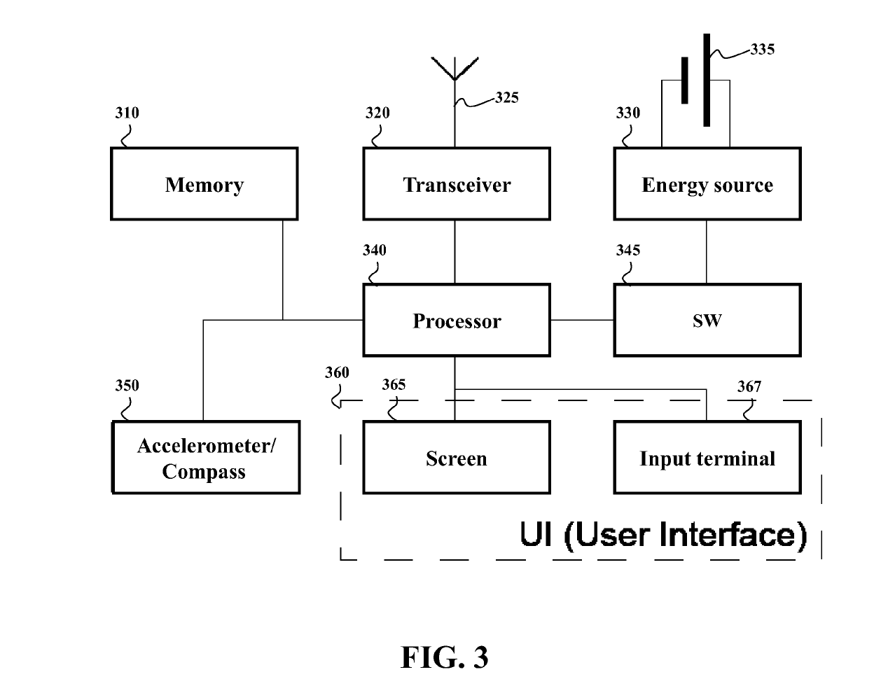

As discussed above, Applicants herein generally recognized the need and the advantages of social interactions that unite people without the use of the Internet. Moreover, the Applicants further recognize the possibility of adapting technology used to connect the technical devices to form a wireless ad-hoc social network. Furthermore, a size and a coverage of the network 100 is usually much less that the coverage of the Internet. However, in some circumstances the limited reach of the network 100 is advantageous. For example, the network 100 can be rapidly formed by members of a group temporarily having a common interest and located in a vicinity of each other, for example attendees of a conference or vacationers at a resort. r In such network, each user may know that every broadcasted message can be of interest for any other user of the network, which is not readily possible for the users of Internet at large. FIG. 2 and FIG. 3 show examples of software and hardware modules of an electronic device according to various embodiments of the invention. The modules of FIGS. 2 and 3 are provided for illustration purposes only. As should be readily appreciated, various implementations and combinations of such modules are within the scope of the invention. In one embodiment, each electronic device of the network, e.g., the first electronic device 110, includes a transceiver module 210 for establishing a communication path 215 with the second electronic device and for generating an identification code 212 associated with the second electronic device. The communication path 215 is formed by a set of links, such as links 150, 152, 154, and 156. Each link connects two electronic devices located within a single radio hop in the network.

In some embodiments, the transceiver module includes a transceiver 320 having an antenna 325 for transmitting and receiving data, and a memory 310 for storing a routing table 217 including routing data representing at least a part of the communication path. For example, the routing data can indicate that the communication path between the first electronic device and the second electronic device includes a link to a third electronic device of the plurality of electronic devices, such that the transceiver, according to the routing table, transmits the data for the second electronic device to the third electronic device.

In some embodiments, the routing table upon joining the network is empty. In order to discover the topology of the network and populate the routing table, the transceiver module broadcasts 219 an identification packet 218 including at least part of the routing data, and modifies 219 the routing table in response to receiving a plurality of identification packets broadcasted by the plurality of electronic devices of the network.

The memory 310 can be, e.g., a permanent memory, random access memory (RAM), or combination thereof. The electronic device also includes an energy source 320, e.g., a battery 325, and a processor 340 for executing software 345 of the electronic device, including an operating system and proprietary software modules, such as modules of FIG. 2. In one example, the processor includes one or more microprocessors that may be programmed using software 345 (e.g., microcode) to perform various functions discussed herein. In another example, the processor includes a combination of dedicated hardware to perform some functions and a controller or processor (e.g., one or more programmed microprocessors and associated circuitry) to perform other functions. Examples of processor 340 that may be employed in various embodiments of the present disclosure include, but are not limited to, conventional microprocessors, application specific integrated circuits (ASICs), and field-programmable gate arrays (FPGAs).

In one embodiment, the electronic device includes a contacts module 220 for maintaining profiles 222 of users associated with other electronic devices of the network and for mapping 225 between the profiles and corresponding identification codes in response to establishing the communication path 215. For example, the first electronic device can maintain a list of contacts of the user in the memory 310. If the second user from that list joins the network, the corresponding identification code is generated and the contacts modules determines that that the second user is in the contact list, and maps the identification code corresponding to the second electronic device to the profile of the second user stored in the memory. At that moment, the first user of electronic device may receive a message, such as the message 140, that the second user from the contact list with a name “Fred” joined the network. Similarly, such message or any other status notification of the users from the contact list can appear for the first user when the first electronic device connects to the network.

In one embodiment, the electronic device includes a social interaction module 230 for searching the second electronic device based on the mapping and for enabling a social interaction 235 with the second electronic device over the communication path 215. As should be readily appreciated, in various embodiments, the social interaction module can perform various social interactions over the communication path that is currently performed by various social networks over the Internet.

The social interactions includes, but is not limited to, various types of information exchange between two or more individuals, such as voice and/or video communications, exchange and posting of text messages, scheduling of events, posting calendar entries and status updates, exchanging and posting geographical locations of the users, etc. The social interactions may also include management of profiles of the users, statuses of the users, and locations of the users, requests to form or join groups of the users and a maintaining a list of contacts and groups of contacts of the first user, exchanging profiles of the users according to permissions specified the users, and forming groups based on the requests in response to the exchange of the profile.

The social interaction module of the electronic device may provide functionality and encouraged individual users to create profiles containing various information about themselves, upload pictures of themselves to their profiles, post blog entries for others to read, search for other users with similar interests, and compile and share lists of contacts. In addition, user profiles often have a section dedicated to comments from friends and other users. To protect user privacy, in one embodiment, the social interaction module has controls that allow users to choose who can view their profile, contact them, add them to their list of contacts.

In one embodiment, the social interaction module 235 searches for the user in the network based on the profile of the user. For example, the first user requests the first electronic device to search for a user “Fred.” The first electronic device searches the mapping 225 and return to the first user an indicator 255 of the user “Fred,” if the mapping indicates that the connection path between the first electronic device and the electronic device of Fred is established, i.e., the first electronic device and the Fred's electronic device are connected to the network 100. The indicator 255 can be any message suitable to indicate the presence of the electronic device of Fred. For example, in one embodiment, the indicator is an image, such as the image 140, rendered on a screen associated with the first electronic device. In alternative embodiments, the indicator is a sound or tactile signal, e.g., vibration or a voice message. Other examples of various functionalities of social networking system and the social interaction module are described in more details below.

In some embodiments, the social interaction module of the electronic device is configured for exchanging or synchronizing information of the user with the other users of the network. For example, upon joining the network, the electronic device, in a manner similar to the broadcasting identification packet, may broadcast some or all information from the profile of the user or information about friends of the user, e.g., from a list of contacts of that user. Such exchange of the contacts of the user enables “Friends of Friends” functionality described below. In some embodiments, the exchange of information is according to permissions set up by the user of the electronic device.

Such social interaction functionality can be useful in various situations including rapid creation of a proprietary network. For example, the network 100 can be formed for members participating in a conference. Using information exchange functionality, profiles of the users, i.e., members of the conference, stored at one electronic device of a user, e.g., a coordinator of the conference, can be distributed to all other members. Additionally, the coordinator can possess private information in the profile of each user, such as personal contact information, and date of birth. However, according to one embodiment of the invention, the coordinator or the user can set the permissions to exchange only part of that information, e.g., name and place of work.

In some embodiments, the electronic device includes a user interface module for rendering output information to and for receiving input information from the first user of the first electronic device. For example, one embodiment includes a user interface (UI) 360 having a screen 365 and an input terminal 367, e.g., a keyboard. In another embodiment, the user interface module includes a touchscreen having an output layer for rendering output information and an input layer for inputting information. For example, the input layer can include at least one of a conductive layer, an ultrasonic waves layer, an electrostatic field layer, or combination thereof.

Another embodiment takes an advantage of recognition that an electronic device can be used in conjunction with another electronic device of a different kind (referred to as “external device”), such as a mobile phone 265. Thus, it can be advantageous to reuse some of the modules of the electronic device. Accordingly, in one embodiment of the invention, the user interface module includes a connector module 260 for connecting the first electronic device to an external device 265 such that the user interface module renders the output information on the external device, and receives the input information from the external device. In those embodiments, the screen 365 and the input terminal 367 can be implemented on the external device 265. The connector module can use input/output ports, e.g., a USB port, of the external and the electronic devices to connect them to each other. In alternative embodiment, the connector module connects the external and the electronic devices wirelessly, using, e.g., a Bluetooth protocol.

### Personal Contacts

Some embodiments of the invention are based on a realization that the ad-hoc social networking can be used not only for remote social interactions, but also as a starting point for face-to-face social contacts and interactions. Because the coverage of the ad-hoc social network employing the principles of the invention is typically much less than the coverage of the Internet, the physical proximity of the users can be used to promote face-to-face communication.

Based on this realization, some embodiments include a reference module 250 for determining at least one of a direction and a distance from the electronic device to another electronic device. Using the reference module, the first user can locate the second user and decide on a possibility of the personal contact. For example, the reference module can help to understand the first user, that the user “Fred” with whom the first user just established the contact is located in a lounge of a hotel they both happened to stay. And thus, the first user can join Fred in the lounge, preferably after asking permission. In various embodiments, the electronic devices are equipped with maps of the neighborhood and/or premises to facilitate the navigation.

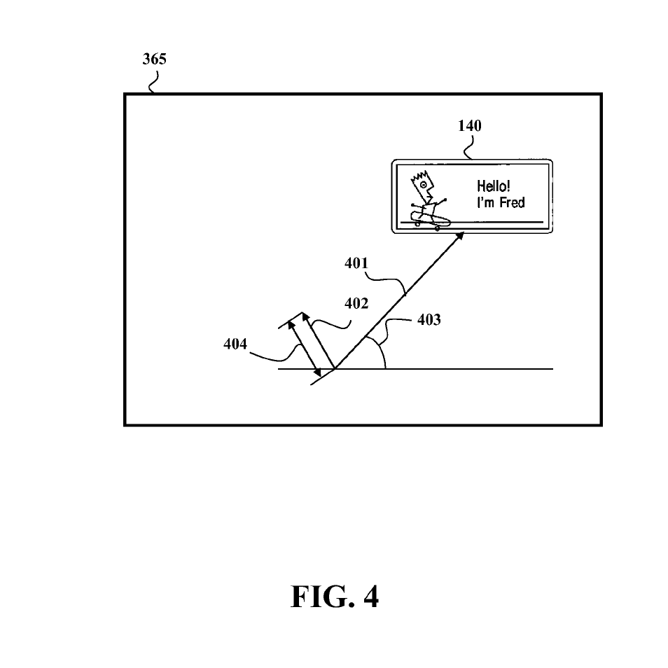

For example, in one embodiment the user interface module renders, upon request from the reference module, the indicator 255 of the second electronic device on a screen, such that a geometric parameter of the indicator on the screen is a function of at least one of the direction and the distance. FIG. 4 shows an example of indicating to the user of electronic device the distance and/or the direction to another user. For example, the indicator can be the image 140, and the geometric parameter can include dimensions of the image 140 and a location of the image on the screen. For example, a size of the image 140 can be proportional to the distance. Also, the location of the image on the screen can indicate the direction to the user. Additionally or alternatively, the indicator can include a line or an arrow 401 or 402 and the geometric parameter includes a length 404 and an orientation 403 of the line, i.e., the length of the line on the screen is a function of the distance, and an orientation of the line on the screen is a function of the direction.

In some embodiments of the invention, the reference module includes global positioning service (GPS) system. However, alternative embodiments are based on another realization that the electronic devices of the ad-hoc network can be used in premises or part of the world wherein global positioning service (GPS) is unavailable. Also, the users of the network can be so close to each other that the GPS system would not be very useful. Therefore, in some embodiments, alternatively or additionally to GPS system, the reference module includes an accelerometer and a compass 350 for determining at least one of a spatial position and an orientation of the first electronic device. For example, the reference module can determine an initial position of the electronic device relative to the second electronic device and can update the position and the orientation based on the accelerometer and the compass.

In one embodiment, the initial position is determined based on a measurement of power present in a received radio signal, i.e., received signal strength indicator (RSSI). For example, the reference module analyzes RSSI of signals received from other electronic devices with known coordinates. On embodiment uses RSSI and the coordinates of three other electronic devices to perform triangulation. The electronic device may broadcast its coordinates periodically or on demand. In alternative embodiment, only RSSI is used to determine a relevant distance. Additionally or alternatively, the reference module can used other devices with known coordinates to determine coordinates of the electronic device. For example, one embodiment uses ZigBee communication protocol to form the network. In that embodiment, fixed position of a ZigBee coordinator can be used to determine coordinates of the electronic device.

In one embodiment, after determining the initial position of the electronic device using, e.g., GPS or triangulation, the position is updated using accelerometer and compass. Additionally or alternatively, the position of the device can be periodically updated using the GPS or the triangulation.

### Wireless Ad-Hoc Network

A wireless ad hoc network employing the principle of the invention is a decentralized wireless network and can be implemented in variety of ways, such as according to examples described below. An ad-hoc network is made up of multiple “nodes” connected by “links”. The node includes the electronic device according to some embodiments of the invention.

The network allows any two nodes to communicate, often via other nodes that relay the information. A “path” is a series of links that connects two nodes. Usually, there are multiple paths between any two nodes. Nodes are often limited by transmitter power (transmission range) and available energy resources. Transmitter power often consumes the most energy in the node. According to the inverse square law, it is more energy efficient to relay information across a network via multiple nodes.

In ad-hoc networks, nodes typically do not start out familiar with the topology of their networks; instead, nodes discover the topology. The basic idea is that a new node may announce its presence and should listen for announcements broadcast by its neighbors. Each node learns about nodes nearby and how to reach them, and may announce that it, too, can reach them.

The ad hoc routing protocols can be broadly categorized, e.g., in pro-active (table-driven) routing, reactive (on-demand) routing, flow-oriented routing, hierarchical routing protocols, multicast routing. For example, pro-active (table-driven) routing protocol maintains fresh lists of destinations and their routes by periodically distributing at least part of routing tables throughout the network. On the other hand, reactive (on-demand) routing protocol finds a route on demand by flooding the network with route request packets.

### Routing Table

A routing table is a data table stored in a memory of the electronic device that lists the communication paths to other electronic devices of the network. In some embodiments, the routing table of the electronic device includes routing data about the topology of the network immediately around that electronic device. The construction of routing tables is an objective of routing protocols.

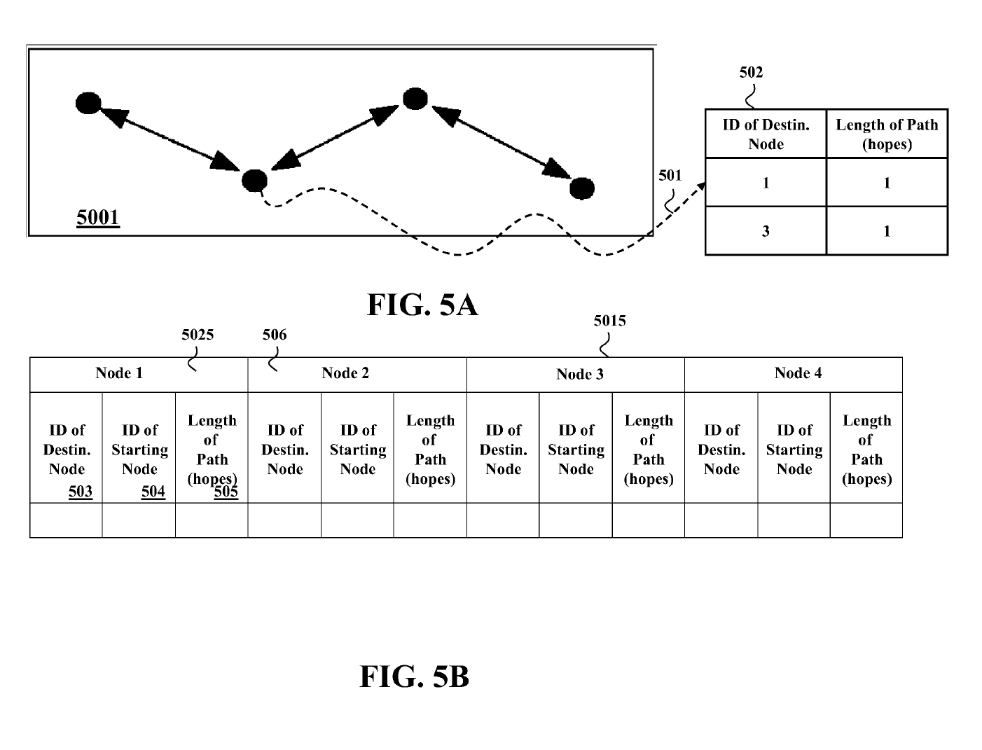

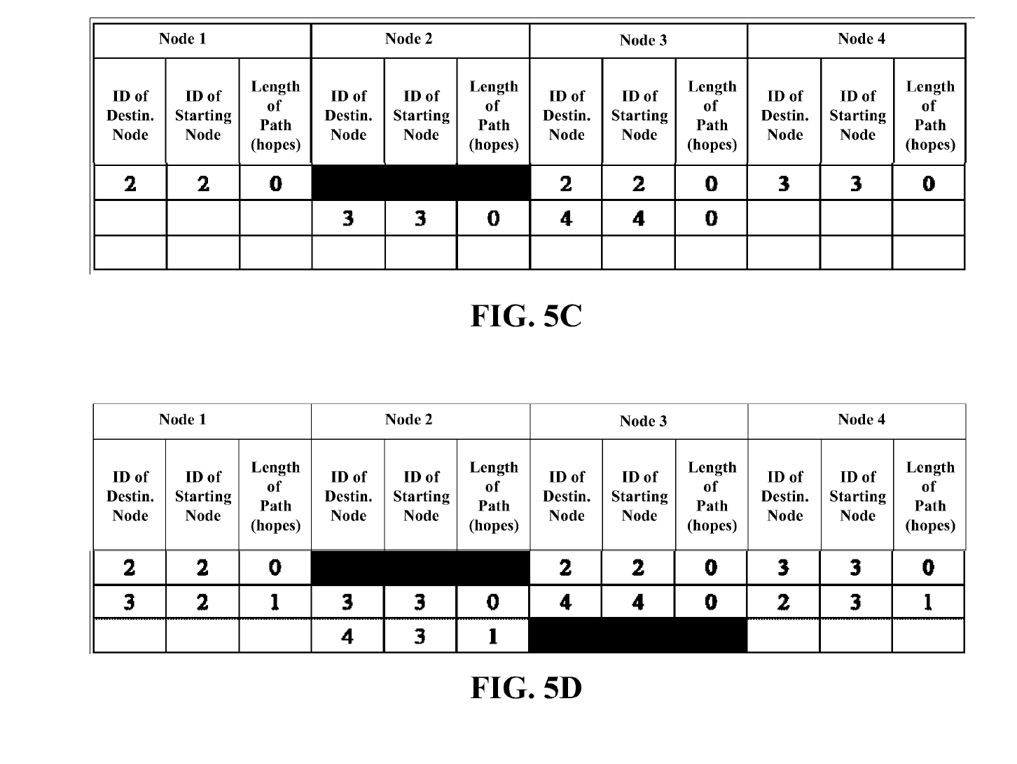

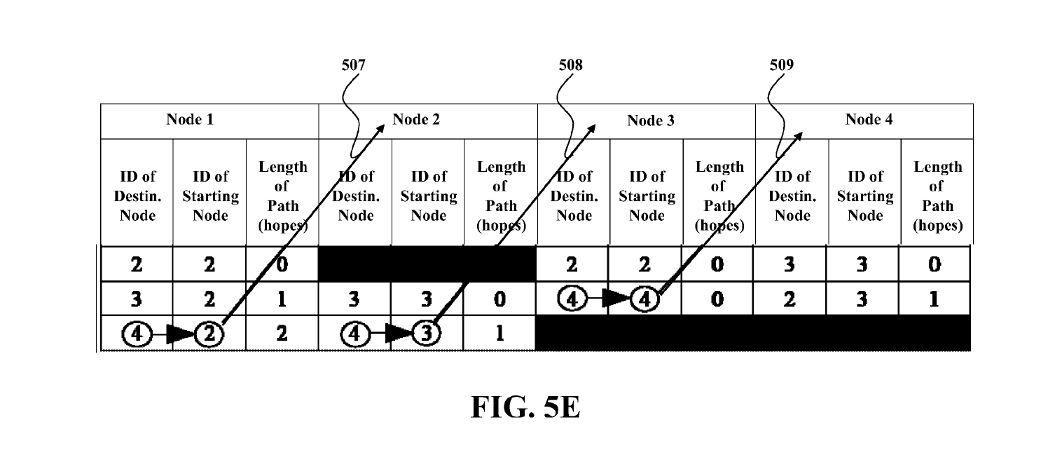

FIG. 5A shows an example of a portion 5001 of the wireless ad-hoc network 100. This example illustrates population of the routing tables of the electronic devices represented by nodes 1, 2, 3 and 4. For example, a table 5015 of FIG. 5B illustrates the structure of those routing tables. For each node, e.g., the first Node 5025, the routing table includes identification (ID) 503 of a destination node, e.g., the second node 506 that has to receive the information from the first node transmitted over the communication path. The routing table also includes ID of a starting node 504 that indicates a node connected with the first node by a link that has to receive the information from the first node for the second node, and forward the information further to the second node according to the communication path. The column 505 indicate the length of the communication path, e.g., in hopes.

Thus, if the first and the second electronic device are located within a single radio hop to each other, they can communicate directly over the communication link. However, in some situations, the communication path includes multiple links. Thus, the routing data can indicate that the communication path between the first electronic device and the second electronic device includes a link to a third electronic device of the plurality of electronic devices, such that the transceiver, according to the routing table, transmits the data for the second electronic device to the third electronic device.

Initially, at least in this example, the table 5015 is empty. Thus, the transceivers of the nodes broadcasts 501 an identification packet that includes only ID of the nodes. Upon receiving a plurality of identification packets broadcasted by the plurality of nodes of the network, the transceiver of each node modifies the routing table, as shown in FIG. 5C. Specifically, the nodes 1 and 4 have communication links with only one another node, i.e., the nodes 2 and 3, respectively. Thus, their corresponding routing tables include only one entry representing the communication path to those nodes. The length of 0 hopes indicates that the nodes are located within a single radio hop from each other. In contrast, the nodes 2 and 3 have communication links with multiple nodes, which is reflected in their routing tables. For example, the node 2 is within a single radio hop with nodes 1 and 3, and the routing table of the node 2 is modified to include the information representing the communication paths to those nodes.

Next, the transceivers of the nodes broadcast not only the identification of their own nodes, but also identification of the nodes with known communication paths. For example, a table 502 illustrates the structure and the data of such identification packet broadcasted at this step by the node 2. FIG. 5D illustrates the routing table modified in response to receiving the plurality of identification packets. The broadcasting of identification packets can be repeated as many times as necessary. For example, in different embodiments, the broadcasting is performed periodically, on demand, or in response to the modification of corresponding routing table.

FIG. 5E illustrate populated routing tables. The arrows 507, 508, and 509 indicate the communication path from the node 1 to the node 4. As indicated by the arrows, the node 1 has to transmit data for the node 4 to the node 2 and the communication path has two hopes, i.e. one hope from the node 2 to the node 3 and the second hop from the node 3 to the node 4. As should be readily appreciated, various other routing protocols are within the scope of the invention, such as the protocol outlined below.

### Wireless Routing Protocol

The Wireless Routing Protocol (WRP) is a proactive unicast routing protocol for mobile ad-hoc networks (MANETs). WRP uses an enhanced version of the distance-vector routing protocol, which uses the Bellman-Ford algorithm to calculate paths. Because of the mobile nature of the nodes within the MANET, the protocol introduces mechanisms which reduce route loops and ensure reliable message exchange. WRP uses a set of tables to maintain more accurate information. The tables that are maintained by a node are the following: distance table (DT), routing table (RT), link cost table (LCT), and a message retransmission list (MRL).

The DT represents the network view of the neighbors of a node. The DT includes a matrix where each element includes the distance and the penultimate node reported by a neighbor for a particular destination. The RT includes the up-to-date view of the network for all known destinations. The RT keeps the shortest distance, the predecessor node (penultimate node), the successor node (the next node to reach the destination), and a flag indicating the status of the path. The path status may be a simple path (correct), or a loop (error), or the destination node not marked (null).

The LCT includes the cost (e.g., the number of hops to reach the destination) of relaying messages through each link. The cost of a broken link is infinity. The LCT also includes the number of update periods (intervals between two successive periodic updates) passed since the last successful update was received from that link. The number of update periods can be used to detect links breaks. The MRL includes an entry for every update message that is to be retransmitted and maintains a counter for each entry. This counter is decremented after every retransmission of an update message. Each update message includes a list of updates. A node also marks each node in the RT that has to acknowledge the update message it transmitted.

Once the counter reaches zero, the entries in the update message for which no acknowledgments have been received are to be retransmitted and the update message is deleted. Thus, a node detects a link break by the number of update periods missed since the last successful transmission. After receiving an update message, a node updates the distance for transmission neighbors, and also can check the other neighbors' distance to improve convergence.

Nodes periodically exchange routing tables with their neighbors via update messages, or whenever the link state table changes. The MRL maintains a list of which neighbors are yet to acknowledge an update message, so they can be retransmitted if necessary. Where there is no change in the routing table, a node can be required to transmit a ‘hello’ message to affirm its connectivity. When an update message is received, a node updates its distance table and reassesses the best route paths. The node can also perform a consistency check with its neighbors, to help eliminate loops and speed up convergence.

### ZigBee

ZigBee is a specification for a suite of high level communication protocols using small, low-power digital radios based on the IEEE 802.15.4-2003 standard for Low-Rate Wireless Personal Area Networks (LR-WPANs), such as wireless light switches with lamps, electrical meters with in-home-displays, consumer electronics equipment via short-range radio. ZigBee is targeted at radio-frequency (RF) applications that require a low data rate, long battery life, and secure networking.

ZigBee's protocols uses ad-hoc on-demand distance vector to automatically construct a low-speed ad-hoc network of nodes. The current profiles derived from the ZigBee protocols support beacon and non-beacon enabled networks. Where other protocols can mask poor sensitivity or other esoteric problems in a fade compensation response, ZigBee radios have very tight engineering constraints: they are both power and bandwidth constrained. Thus, radios are tested to the ISO 17025 standard with guidance given by Clause 6 of the 802.15.4-2006 Standard. Most vendors integrate the radio and microcontroller onto a single chip for getting smaller devices.

Applicants herein have appreciated the advantage of using a standard protocol, such as ZiBee, to implement the wireless ad-hoc network, according to various embodiments of the invention. Specifically, Applicants recognized the possibility of adapting the ZigBee protocol used to connect the technical devices in a hierarchical structure to form a decentralized wireless ad-hoc network for facilitating social interactions among the users. Accordingly, in some embodiments of the invention, the electronic device includes a transceiver 320 for connecting to the network based on a ZigBee communication protocol. In those embodiments, the ad-hoc decentralized communication network is formed based on the ZigBee communication protocol.

In some embodiments, the electronic device includes ZigBee Router (ZR): i.e., a router implementing ZigBee communication protocol that can act as an intermediate router, passing on data from other devices. In various embodiment, the ZigBee Router uses the routing tables of FIGS. 5A-E for discovery and communication functionality.

ZigBee standard specifies operation in the unlicensed 2.4 GHz (worldwide), 915 MHz (Americas and Australia) and 868 MHz (Europe) ISM bands. In the 2.4 GHz band there are 16 ZigBee channels, with each channel requiring 5 MHz of bandwidth. The 2.4 GHz band provides up to 250 kbit/s, 915 MHz provides up to 40 kbit/s and 868 MHz provides a data rate up to 20 kbit/s. The actual data throughput will be less than the maximum specified bit rate due to the packet overhead and processing delays.

The radios use direct-sequence spread spectrum coding, which is managed by the digital stream into the modulator. Binary phase-shift keying (BPSK) is used in the 868 and 915 MHz bands, and Offset quadrature phase-shift keying (OQPSK) that transmits two bits per symbol is used in the 2.4 GHz band. The raw, over-the-air data rate is 250 kbit/s per channel in the 2.4 GHz band, 40 kbit/s per channel in the 915 MHz band, and 20 kbit/s in the 868 MHz band. Transmission range is between 10 and 75 meters (33 and 246 feet) and up to 1500 meters for ZigBee pro, although it is heavily dependent on the particular environment. The output power of the radios is generally 0 dBm (1 mW).

### Social Interactions

In some embodiments, the electronic device provides various services for assisting users in locating, and establishing contact relationships with other users connected the ad-hoc network 100. For example, in one embodiment, users can identify other users based on their affiliations with particular group or organizations. The electronic device may also provide a mechanism for a user to selectively establish contact relationships or connections with other users, and to grant permissions for such other users to view personal information of the user. The electronic device may also include features for enabling users to identify contacts of their respective contacts. In addition, the electronic device may automatically notify users of personal information updates made by their respective contacts.

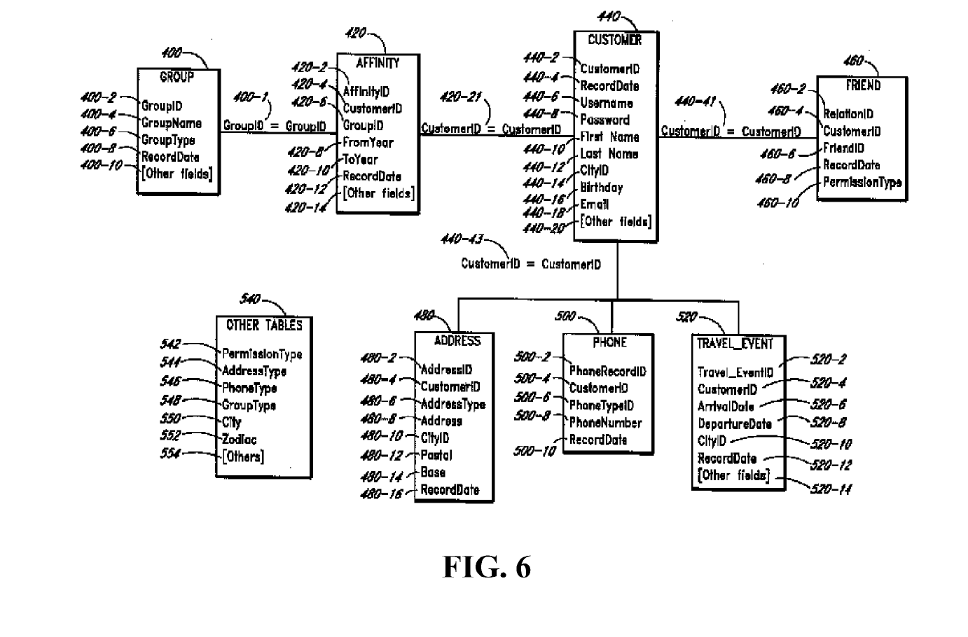

FIG. 6 outlines an example of the data structure of a database stored by the electronic device to facilitate social interaction among users according to some embodiments. In various embodiment, the database includes one or combination of: (1) Customer Table 440; (2) Friend Table 460; (3) Group Table 400; (4) Affinity Table 420; (5) Address Table 480; (6) Phone Table 500; and (7) Travel Event Table 520.

The Customer Table 440 includes one record for each unique user. The key field in this table is CustomerID 440-2. All information stored in the various database tables relating to a particular member is linked together by a unique number in this field. Other important fields in this table include information used by users to login to the system (Username 440-6 and Password 440-8), information which helps users identify each other (First Name 440-10, Last Name 440-12, and E-mail 440-20), information required to provide Birthday Notification (Birthday 440-16) and information required to provide Crossing Paths notification (CityID 440-14). Each record in the Customer Table 440 is time-stamped via the RecordDate field 440-4. Other fields 440-22 can also be included in the Customer Table 440 (and the other tables as well).

The Friend Table 460 relates users to each other. Each record in the table represents a relationship between one user, identified by CustomerID 460-4, and another, identified by FriendID 460-6, with a certain level of permissions 460-10. The user interface of the system provides a multitude of ways for users to view information about other users, and every one of these ways relies on a database query of the Friend Table 460 to determine the list of other users whose information a particular user may see. Each record is time-stamped via the RecordDate field 460-8 so that users may be notified when their contacts' records change. Each record is uniquely identified by a RelationID 460-2.

The Group Table 400 contains one record for each unique group with which users may affiliate. Each group is identified by a GroupName 400-4 and GroupType 400-6. Examples of these groups would be GroupName 400-4=“Massachusetts Institute of Technology” (GroupType=“University”) and GroupName 400-4=“Sigma Chi” (GroupType=“Fraternity”). Each record has a time-stamp 400-8 and a unique identifier 400-2.

Each record of the Affinity Table 420 relates a user, identified by CustomerID 420-4, to a group, identified by GroupID 420-6. If a user affiliates with six groups, there would be six records in the Affinity Table 420. This table stores information about the time period of a user's affiliation with a particular group in the FromYear and ToYear fields 420-8, 420-10 so that the system may help users find their contemporaries. Each record is time-stamped 420-12 so that the system may report to users when other users join the group, has a unique identifier 420-2 and can include additional fields 420-14.

The Address Table 480 stores information for any number and kind of addresses for a particular user, identified by CustomerID 480-4. For instance, if a user wants to make his home address, work address and summer home address available to his contacts, there would be three records for that user in the Address Table 480, each being identified in part by an appropriate AddressType 480-8 (e.g., home, work, summer home). Each record is time-stamped 480-16 so that the system can notify users when their contacts have added or modified address information and has a unique identifier 480-2. Address information is conventional, including street Address 480-8, CityID 480-10, Postal code 480-12, and military Base 480-14 fields.

The Phone Table 500 is directly analogous to the Address Table 480, but it stores telephone and fax number information instead of address information. Each record is identified by a unique PhoneRecordID 500-2 and includes the CustomerID 500-4 of the user whose phone information is contained in the record, a phone type ID 500-6 indicating, e.g., whether the record is for a telephone or fax, the phone number 500-8 and a time-stamp 500-10.

The Travel Event Table 520 stores information about users' travel plans. This table is required to notify users when their travel plans intersect with the travel plans of their contacts. A record in the Travel Event Table 520 includes the CustomerID 520-4 of the user whose travel information is contained in the record, arrival and departure dates 520-6, 520-8 and a CityID 520-10 identifying the travel destination. Each record is uniquely identified by a Travel_EventID 520-2 and is time-stamped with a Record Date 520-14.

In various embodiments, a multitude of other tables 540 are used to enable a variety of user services. The Permission Type Table 542 includes one record for each of the varieties of permission levels the system allows members to assign to their contacts in the Friend Table 460.

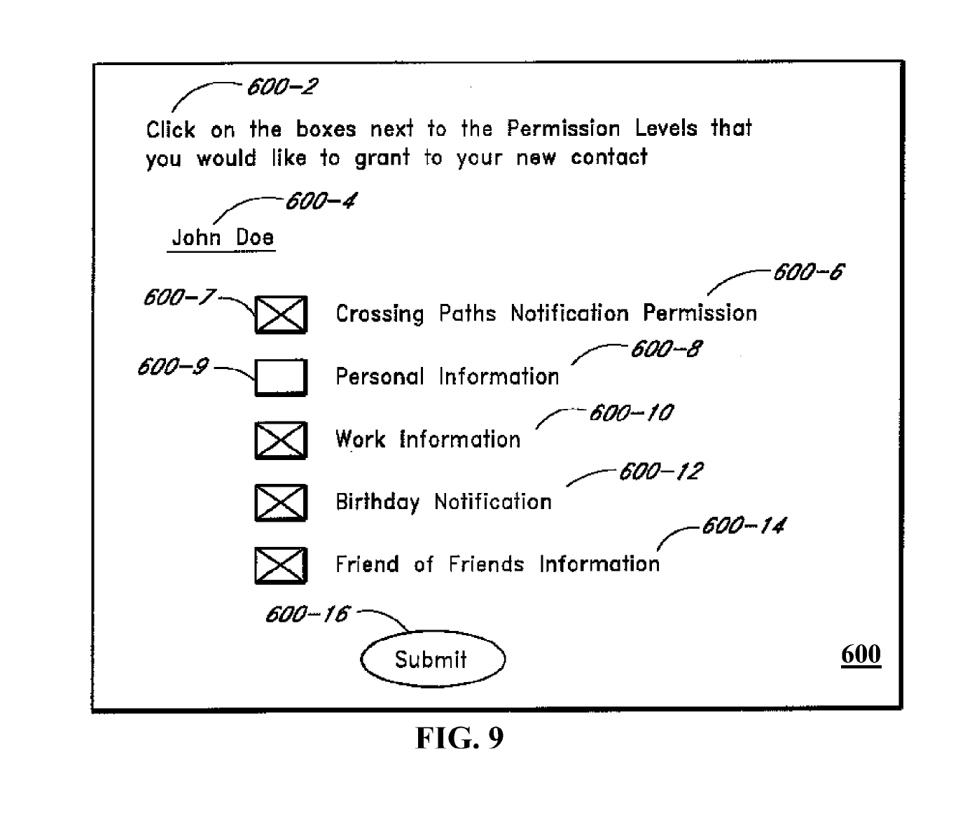

In one embodiment, as illustrated in FIG. 9, permission information is grouped into five categories for the purpose of user interface simplicity (crossing paths notification permission 600-6, personal information 600-8, work information 600-10, birthday notification 600-12, and friends of friends information 600-14). However, the Permission Type table 542 could just as easily be structured to allow members to grant and deny access to information on a field by field basis.

The City Table 550 stores latitude and longitude to notify users when their contacts travel within a defined geographical radius. The Zodiac Table 552 allows the system to associate birthdays with signs of the Zodiac and thereby notify which of their contacts have compatible astrological signs on a particular day. The AddressType, PhoneType and GroupType tables 544, 546, 548 define the types of address, phone and group that can be defined in the respective Address, Group and Phone tables 480, 400, 500. However, as skilled artisan would readily appreciate, other structures of such database are possible and within the scope of the invention.

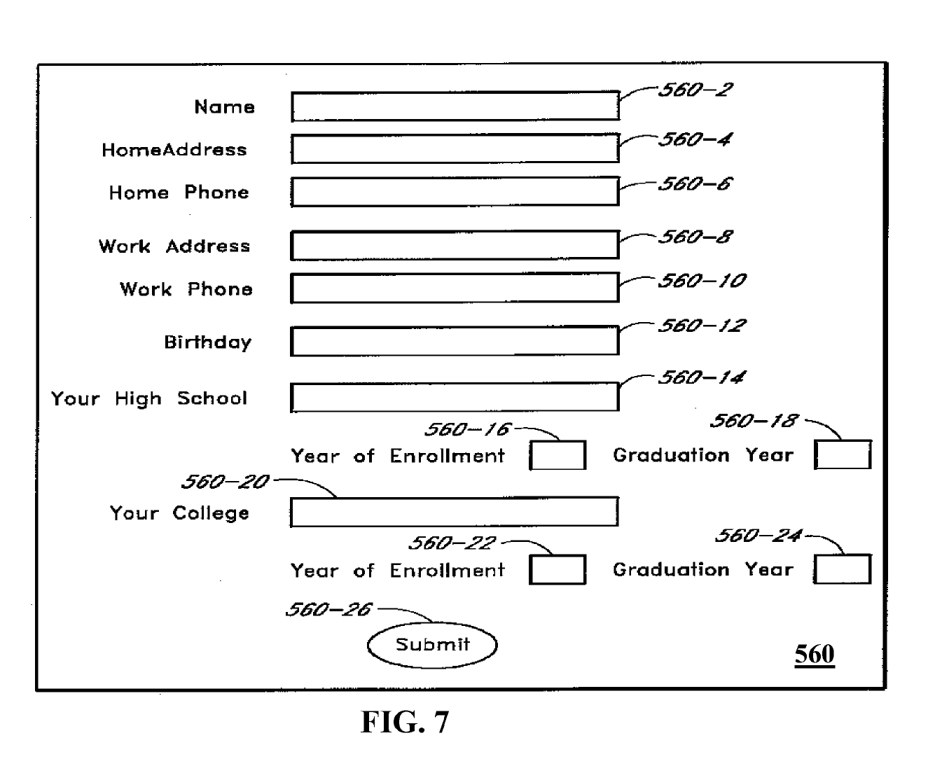

FIGS. 7 through 11 display pseudo software graphical user interfaces (GUIs). In various embodiments, the GUI is rendered by the User Interface module, as described above.

Referring now to FIG. 7, a pseudo GUI 560 is shown that allows members to enter information about themselves in order to create a personal data record. Users can enter information in this GUI in various data fields. In the preferred embodiment, these fields include: Name 560-2, Home Address 560-4, Home Phone 560-6, Work Address 560-8, Work Phone 560-10, Birthday 560-12, High School 560-14, Year of High School Enrollment 560-16, High School Graduation Year 560-18, College 560-20, Year of College Enrollment 560-22, and College Graduation Year 560-24.

In certain of these data fields, the user can specify groups with which he wishes to affiliate himself, and the beginning and ending dates of the affiliation. In the preferred embodiment, the data fields High School 560-14 and College 560-20 represent categories of groups. In the data field Year of High School Enrollment 560-16, the user enters the beginning date of the affiliation with the group specified in the data field High School 560-14. In the data field High School Graduation Year 560-18, the user enters the ending date of the affiliation with the group specified in the data field High School 560-14. In the data field Year of College Enrollment 560-22, the user enters the beginning date of the affiliation with the group specified in the data field College 560-20. In the data field College Graduation Year 560-24, the user enters the ending date of the affiliation with the group specified in the data field College 560-20. In both of these cases, the beginning date and ending date establish a date range during which time the user was affiliated with the group in question.

Once the user enters information in each data field in the GUI 560 shown in FIG. 7, he clicks the Submit button 560-26 (or performs some equivalent action) and the information entered can be transferred to other electronic devices of the network over corresponding communication paths. For example, in one embodiment, the information is broadcasted to all electronic devices of the network. In another embodiment, the information is transmitted to electronic devices of the users affiliated with the user. In another embodiment, the information is transmitted to users specified by the user for this transmission.

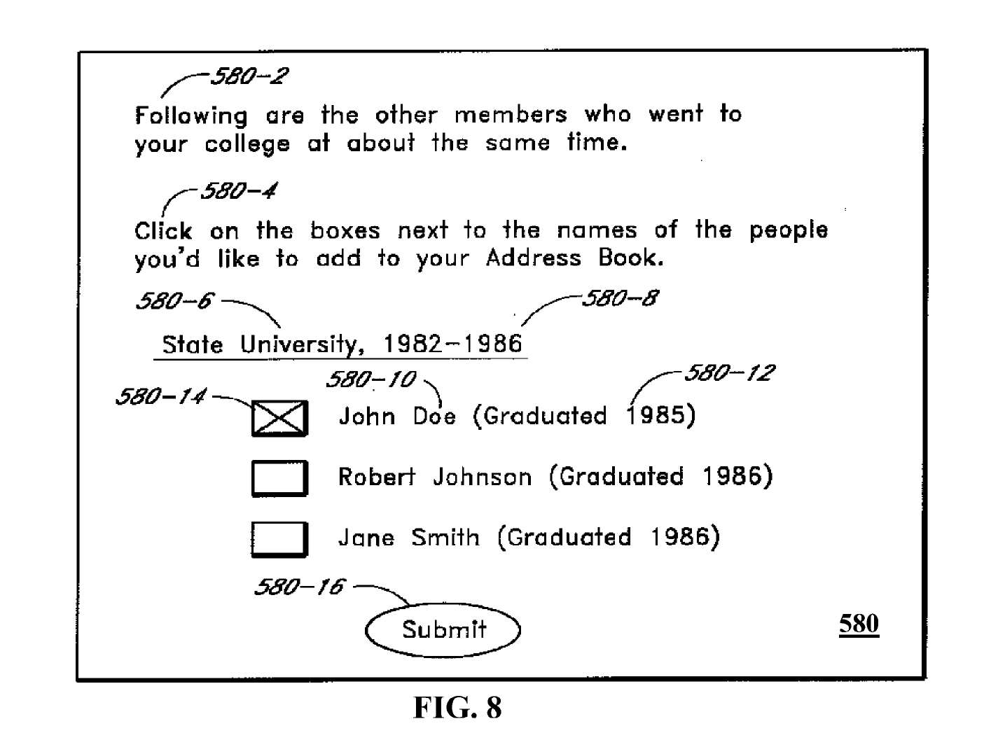

Referring now to FIG. 8, a pseudo GUI 580 is shown that allows a first user to select other users they wish to add to their personal address book. The list of contacts is created based on the group affiliation information the first user enters in the data fields College 560-20, Year of College Enrollment 560-22, and College Year of Graduation 560-24 in the Pseudo Registration GUI 560 shown in FIG. 7. A similar GUI 580 would exist for the group specified in the data field High School 560-14 in the pseudo 560 GUI shown in FIG. 7.

In each version of the GUI 580 shown in FIG. 8, a text description 580-2 at the top of the GUI explains to the first user that other members have been found who had the same affiliation as the first user during the same period of time as the first user. The name 580-6 of the group in which the first and second users share an affiliation is displayed and the date range 580-8 of the first user's affiliation with that group is displayed.

If a second user has specified the same group affiliation as that specified by the first user in the College 560-20 data field, and that second user has specified a date range for that affiliation that intersects with the date range specified by the first user in the Year of College Enrollment 560-22 and College Graduation Year 560-24 data fields, the Name 580-10 of the second user and the ending date 580-12 of the second user's affiliation with that group are displayed, e.g., as the image 140.

A second text description 580-4 at the top of the GUI 580 instructs the first user to select any of the second users listed whom the first user wishes to add to his personal address book. If the first user wishes to add a second user to his personal address book, the first user clicks the checkbox 580-14 to the left of the Name 580-10 (e.g., “John Doe”) for that second user. Once the first user has finished specifying the users he wants to add to his address book, he clicks the Submit button 580-16, and the information entered is transferred via the computer communications network 360 to the server computer 330 where it is stored in the appropriate tables 350 of the database 340.

Referring now to FIG. 9, a pseudo GUI 600 is shown allowing a first user to specify which types of data fields from the first user's personal data record to grant a specific second user permission to view. If a first user specifies a second user whom the first user would like to add to his personal address book, as explained in the description of FIG. 8, the second user will receive notification (issued by the contact manager program 343—FIG. 5) that the first user has “linked” to him. If the second user chooses to return the link to the first user, the system will display the pseudo GUI 600 shown in FIG. 9 with the name of the first user 600-5, allowing the second user to set data field permissions for the first user. Unlike the prior art, which does not allow the first user to specify data field permissions for individual other users, the disclosed system allows the first user to specify permissions separately for each individual other user in whose personal database the first user has chosen to be included.

A text description 600-2 at the top of the pseudo GUI in FIG. 9 instructs the first user to specify which types of data fields from the first user's personal data record to allow to appear in the personal address book of the second user, whose name 600-4 is shown below. Several types of data field permission are listed, each with a check box to the left enabling the first user to select or deselect the permission type. For example, to grant the second user 600-4 permission to view the information from the first user's personal data record indicated by the permission type denoted “Crossing Paths Notification Permission,” the first user would check the box 600-7 to the left of the permission type Crossing Paths Notification Permission 600-6. To deny the second user 600-4 permission to view the information from the first user's personal data record indicated by the permission type denoted “Personal Information,” the first user would uncheck the box 600-9 to the left of the permission type Personal Information 600-8.

In one embodiment of the invention, the levels of permission are as follows: Crossing Paths Notification Permission 600-6, Personal Information 600-8, Work Information 600-10, Birthday Notification 600-12, and Friends of Friends Information 600-14. However, the embodiments are not limited to the levels of permission shown in the preferred embodiment and permission categories can be modified as needed.

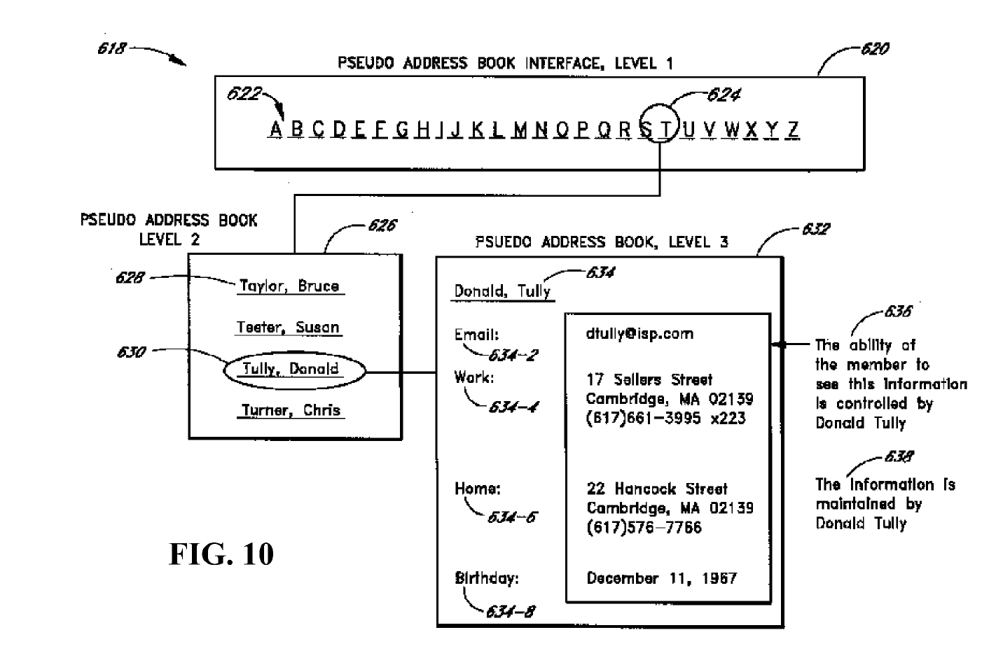

Referring now to FIG. 10, a pseudo GUI 618 that displays the information stored in a user's personal address book is shown. The information in each user's personal address book is customized for that user, as described below. Each first user's personal address book contains information about each second user who has given the first user permission to view information in the second user's personal data record 636. Which categories of each second user's information are displayed in the first user's personal address book is controlled completely by the second user, as explained in the description of FIG. 9. In addition, each second user's information is entered and maintained completely by the second user (e.g., “Donald Tully”), as explained in the description of FIG. 7.

FIG. 10 illustrates the Address Book pseudo GUI 620 at three levels, in which each next level allows the user to view progressively more detail about the contacts in his personal address book.

In level 1 620 of the pseudo address book GUI 618, each letter of the alphabet is shown 622. By clicking on any letter of the alphabet 622, a first user can display a listing of the contacts whose last names begin with the letter of the alphabet selected, and about whom information is stored in the first user's personal address book. This information is displayed in the level 2 626 of the pseudo address book GUI. For example, if the first user clicks on the letter “T” 624 in level 1 620 of the pseudo address book interface, all contacts whose last names begin with the letter T and about whom information is stored in the first user's personal address book will be displayed 628 in level 2 626 of the pseudo address book GUI.

In level 2 626 of the pseudo address book GUI, a listing of the second users whose last names begin with the letter of the alphabet selected in level 1 620 of the pseudo address book GUI, and about whom information is stored in the first user's personal address book, is shown. By clicking on any second user's name, the first user can display the information about that second user stored in the first user's personal address book. This information is displayed in level 3 632 of the pseudo personal address book GUI. For example, if the first user clicks on the second user name “Tully, Donald” 630, the information pertaining to Donald Tully stored in the first user's personal address book will be displayed in level 3 632 of the pseudo address book GUI.

In level 3 632 of the pseudo address book GUI, information 634 is shown about a specific second user that is stored in a first personal address book. Only the categories of information from the second user's personal data record that the second user gave the first user permission to view are displayed. The second user's information is entered and maintained completely by the second user.

In one embodiment, the second user's e-mail address 634-2 is displayed if the second user gave the first user any type of data field permission. The second user's work address and phone number 634-4 are displayed only if the second user gave the first user Work Information permission. The second user's home address and phone number 634-6 are displayed only if the second user gave the first user Personal Information permission. The second user's birthday and birth year 634-8 are displayed only if the second user gave the first user Birthday Notification permission. These permission rules are simply examples from the one embodiment.

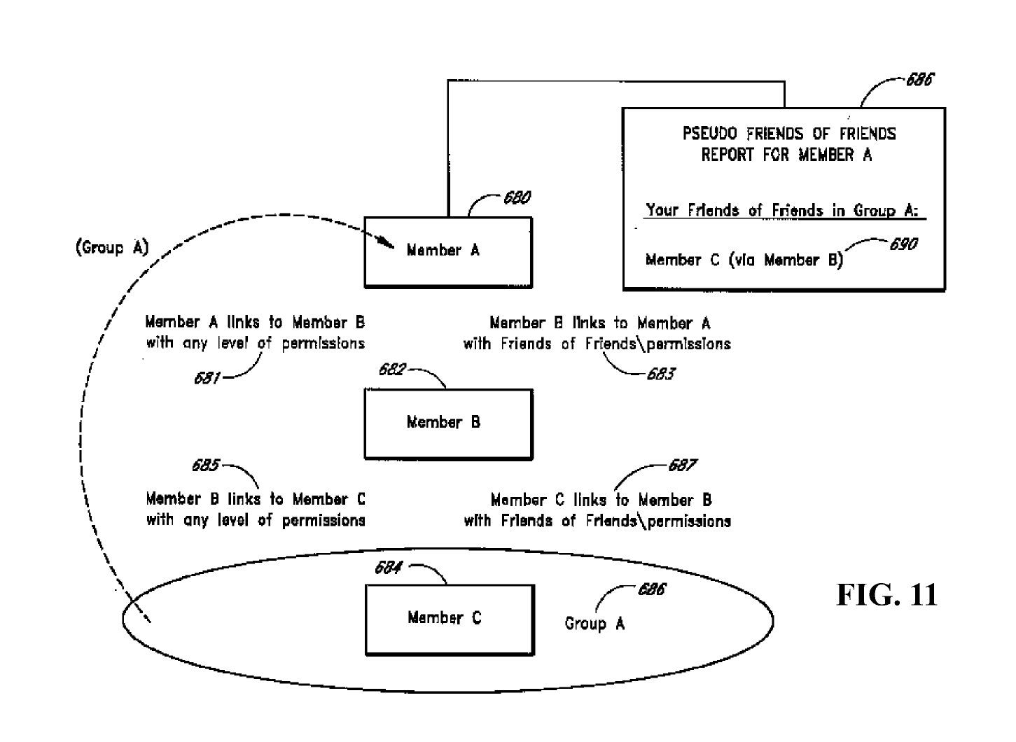

Referring now to FIG. 11, a diagram illustrating the Friends of Friends system is shown. The Friends of Friends system allows a first user to search within the network 100 for the names of contacts of their contacts. After locating a second user who is a friend of a friend, the first user can then link to that second member in order to add the second user to the first user's Personal Address Book.

If a Member A 680 is linked to a Member B 682 with any level of permissions 681 and the Member B 682 is linked to a Member C 684 with any level of permissions 685, then if Member C 684 grants to Member B 682 Friends of Friends permissions 687 and Member B 682 also grants to Member A 680 Friends of Friends permissions 683, then Member A is eligible to receive Friends of Friends notification about Member C. When a first user performs a Friends of Friends search, the results of the search includes, e.g., all second users who have affiliated themselves with a group with which the first user is affiliated, so long as the first user is eligible to receive Friends of Friends notification about those second users, as described above. For example, if Member A and Member C both belong to Group A 686, and Member A is eligible to receive Friends of Friends notification about Member C, then the result of Member A's Friends of Friends search 688 generated by the electronic device includes Member C 690.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

We claim:

1. A wireless ad-hoc network for facilitating social interactions among a plurality of users, the network comprising a plurality of electronic devices associated with the plurality of users, the plurality of electronic devices includes a first electronic device and a second electronic device, the first electronic device comprising:
a transceiver module for establishing a communication path with the second electronic device and for generating an identification code associated with the second electronic device, wherein the communication path is formed by a set of links, each link connects two electronic devices located within a single radio hop in the network;
a contacts module for maintaining a profile of a second user associated with the second electronic device and for mapping between the profile and corresponding identification code in response to establishing the communication path;
a social interaction module for searching the second electronic device based on the mapping and for enabling a social interaction with the second user over the communication path; and
a user interface module for rendering output information to and for receiving input information from a first user of the first electronic device.

2. The wireless ad-hoc network of claim 1, wherein the transceiver module comprises:
a transceiver for transmitting and receiving data; and
a memory for storing a routing table including routing data representing at least a part of the communication path.

3. The wireless ad-hoc network of claim 2, wherein the routing data indicates that the communication path between the first electronic device and the second electronic device includes a link to a third electronic device of the plurality of electronic devices, such that the transceiver, according to the routing table, transmits the data for the second electronic device to the third electronic device.

4. The wireless ad-hoc network of claim 2, wherein the transceiver module broadcasts an identification packet including at least part of the routing data, and modifies the routing table in response to receiving a plurality of identification packets broadcasted by the plurality of electronic devices of the network.

5. The wireless ad-hoc network of claim 4, wherein the transceiver module broadcasts the identification packet in response to modification of the routing table.

6. The wireless ad-hoc network of claim 1, wherein the user interface module comprises:
a touchscreen including an output layer and an input layer, wherein the input layer includes at least one of a conductive layer, an ultrasonic waves layer, an electrostatic field layer, or combination thereof.

7. The wireless ad-hoc network of claim 1, wherein the user interface module comprises:
a connector module for connecting the first electronic device to an external device such that the user interface module renders the output information on the external device, and receives the input information from the external device.

8. The wireless ad-hoc network of claim 1, wherein the first electronic device further comprises:
a reference module for determining at least one of a direction and a distance from the first electronic device to the second electronic device.

9. The wireless ad-hoc network of claim 8, wherein the user interface module renders an indicator of the second electronic device on a screen, such that a geometric parameter of the indicator on the screen is a function of at least one of the direction and the distance.

10. The wireless ad-hoc network of claim 9, wherein the indicator includes a line, wherein a length of the line on the screen is a function of the distance, and an orientation of the line on the screen is a function of the direction.

11. The wireless ad-hoc network of claim 8, wherein the reference module includes an accelerometer and a compass for determining at least one of a spatial position and an orientation of the first electronic device.

12. The wireless ad-hoc network of claim 11, wherein the reference module determines an initial position of the electronic device relative to the second electronic device and updates the position and the orientation based on the accelerometer and the compass.

13. The wireless ad-hoc network of claim 1, wherein the social interaction includes at least one or combination of an on-line voice conferencing, an on-line video conferencing, an on-line emailing, an on-line messaging, an instant messaging, a calendaring, and a message posting, a management of profiles of the users, statuses of the users, and locations of the users, requests to form or join groups of the users and maintaining a list of contacts and groups of contacts of the first user, exchanging profiles of the users according to permissions specified the users, and forming groups based on the requests in response to the exchange of the profile.

14. A wireless ad-hoc network for facilitating social interactions between a plurality of users, the network comprising a plurality of electronic devices associated with the plurality of users, each electronic device comprising:
a transceiver for connecting to the network and for establishing communication paths with the plurality of electronic devices of the network, wherein each communication path is formed by a set of links, each link connects two electronic devices located within a single radio hop in the network ;
a social interaction module for enabling the social interactions with users of at least some of the plurality of electronic devices of the network over the communication path; and
a reference module for determining at least one of a direction and a distance from the electronic device to at least some of the plurality of the electronic devices.

15. A method for a social networking within decentralized, mobile and ad hoc social networking community, comprising:
forming an ad-hoc decentralized communication network based on a ZigBee communication protocol; and
integrating into the communication network a plurality of social interactions including an on-line voice conferencing, an on-line messaging, an instant messaging, a calendaring, and a message posting, a management of profiles of users of the community, statuses of the users, and locations of the users, contacts and groups of contacts of the users, exchanging the profiles of the users according to permissions specified the users, and forming groups based on the requests to join a group.

16. A networkable electronic device, comprising:
a transceiver module for establishing a communication path with at least one other networkable electronic device and for generating an identification code associated with the at least one other networkable electronic device, wherein the communication path is formed by a set of links, each link connects two electronic devices located within a single radio hop in the network;
a contacts module for maintaining a profile of a user associated with the at least one other networkable electronic device and for mapping between the profile and corresponding identification code in response to establishing the communication path;
a social interaction module for searching the at least one other networkable electronic device based on the mapping and for enabling a social interaction with the user of the at least one other networkable electronic device over the communication path; and
a user interface module for rendering output information to and for receiving input information from a user of the networkable electronic device.

17. The device of claim 16, wherein the transceiver module comprises:
a transceiver for transmitting and receiving data;
a memory for storing a routing table including routing data representing at least a part of the communication path; and
a network module for modifying the routing table in response to receiving a plurality of identification packets broadcasted by at least two other networkable electronic devices.

18. The device of claim 16, further comprising a reference module for determining at least one of a direction and a distance to the at least one other networkable electronic device.

19. The device of claim 18, wherein the user interface module renders an indicator of the at least one other networkable electronic device on a screen, such that a geometric parameter of the indicator on the screen is a function of at least one of the direction and the distance.

20. The device of claim 18, wherein the reference module includes an accelerometer and a compass for determining at least one of a spatial position and an orientation of the first electronic device, and wherein the reference module determines an initial position of the electronic device relative to the at least one other networkable electronic device and updates the position and the orientation based on the accelerometer and the compass.
